(19) United States
(12) Patent Application Publication
(10) Pub. No.: US 2025/0177089 A1
(43) Pub. Date: Jun. 5, 2025

(54) AUXILIARY TOOL FOR TOOTH EXTRACTION AND TOOL SET FOR TOOTH EXTRACTION

(71) Applicant: Kazuyoshi SUZUKI, CHIBA (JP)

(72) Inventor: Kazuyoshi SUZUKI, CHIBA (JP)

(21) Appl. No.: 18/725,491

(22) PCT Filed: Feb. 4, 2022
(86) PCT No.: PCT/JP2022/004524

§ 371 Date: Jun. 28, 2024

(51) Int. Cl. A61C 3/14

(52) U.S. Cl. CPC A61C 3/14

(57) ABSTRACT

Provided is a tooth extraction auxiliary tool which can reduce a burden on a tooth serving as a tooth extraction target, an alveolar bone at this tooth extraction target site, and/or adjacent teeth. A tooth extraction auxiliary tool 1 having a first auxiliary substrate 11 and a second auxiliary substrate 12 is used. The first auxiliary substrate 11 is inserted into a recessed portion X0 formed in a tooth X2, and the second auxiliary substrate 12 is tightened with respect to the first auxiliary substrate 11. In this manner, in a state where the first auxiliary substrate 11 is in pressure contact with the tooth X2, a force is applied to the tooth extraction auxiliary tool 1 by using the second auxiliary substrate 12, and the tooth X2 is pulled out from a gum X1.

### TECHNICAL FIELD

The present invention relates to a tooth extraction auxiliary tool.

### BACKGROUND ART

When a tooth is extracted in a dental treatment, in general, the tooth is pinched, extracted, and removed by a dental forceps (pliers) after the tooth is dislocated by inserting a lever (Hebel) into a site of a periodontal ligament around a tooth root between the tooth and an alveolar bone (for example, refer to Patent Literatures 1 and 2).

However, in a case where the tooth is accidentally pushed when the tooth is twisted with the lever, the case may cause the following problems. Nerves may be hurt, blood vessels may be damaged, excessive bleeding may occur, or the alveolar bone may collapse.

Therefore, the present inventor has proposed a tooth extraction auxiliary tool that enables safer and easier tooth extraction (for example, refer to Patent Literature 3). This tooth extraction auxiliary tool includes a screw portion screwed into the tooth and a handle portion, and a non-slip portion is formed on the handle portion. After the handle portion is gripped, the screw portion is screwed into a cavity in a central portion of the tooth. When the screw portion is firmly bitten into the tooth, a force is applied to the handle portion, and the tooth is pulled out from a gum. When a twisting force acts on the tooth root, the tooth relatively easily floats from the alveolar bone. Accordingly, the tooth can be easily extracted. Therefore, a force for extracting the tooth is applied only to the tooth on which tooth extraction is performed without using the lever in extracting the tooth. Accordingly, the tooth extraction is safe since the tooth extraction is less likely to be affected by adjacent teeth or is less likely to affect the adjacent teeth (for example, refer to Patent Literature 4).

### CITATION LIST

### Patent Literatures

Patent Literature 1: Japanese Patent Application Laid-Open No. 2002-291753 (FIG. 1)
Patent Literature 2: Japanese Patent Application Laid-Open No. 2009-119095 (FIG. 15)
Patent Literature 3: Japanese Registered Utility Model No. 3162169
Patent Literature 4: Japanese Registered Utility Model No. 3162226

### SUMMARY OF INVENTION

### Technical Problem

However, the screw portion needs to be firmly bitten into the tooth. Therefore, it is unavoidable that a force acting in a twisting direction at this time is applied to the tooth. Even in this case, when the screw portion is screwed into the cavity in the central portion of the tooth with the handle portion and is fixed to the tooth by being firmly bitten into the tooth, it is preferable that the force acting in the twisting direction is not applied to the tooth so much.

Therefore, an object of the present invention is to provide a tooth extraction auxiliary tool or the like which can reduce a burden on a tooth to be extracted, an alveolar bone at this tooth extraction site, and/or adjacent teeth.

### Solution to Problem

According to a first aspect of the present invention, there is provided a tooth extraction auxiliary tool including a first auxiliary substrate inserted into a recessed portion formed in a tooth, and a second auxiliary substrate. A slit dividing a tip portion and a through-hole extending from a rear end portion to the tip portion are formed in the first auxiliary substrate, and a female screw portion is formed on an inner surface of the first auxiliary substrate. The second auxiliary substrate has a head portion, and a male screw portion extending from the head portion is formed in the second auxiliary substrate. The male screw portion of the second auxiliary substrate is screwed into the female screw portion of the first auxiliary substrate, and the head portion is rotated to tighten the second auxiliary substrate with respect to the first auxiliary substrate such that the slit is pushed and widened and the tip portion of the first auxiliary substrate which is divided by the slit is expanded.

In the tooth extraction auxiliary tool having the above-described configuration, it is preferable that the through-hole is formed in the first auxiliary substrate such that a diameter is reduced at least from an intermediate portion to the tip portion.

In the tooth extraction auxiliary tool having the above-described configuration, it is preferable that the female screw portion is formed in the first auxiliary substrate such that a valley diameter is reduced at least from an intermediate portion to the tip portion.

In the tooth extraction auxiliary tool having the above-described configuration, it is preferable that a protruding portion is formed on an outer surface of the first auxiliary substrate.

According to a second aspect of the present invention, there is provided a tooth extraction auxiliary tool including a first auxiliary substrate inserted into a recessed portion formed in a tooth, and a second auxiliary substrate. A cavity extending from a rear end portion and a communication hole through which the cavity communicates with an external space are formed in the first auxiliary substrate, a female screw portion is formed on an inner surface of the first auxiliary substrate, and a capsule filled with an adhesive is installed in the cavity. The second auxiliary substrate has a head portion, and a male screw portion extending from the head portion is formed in the second auxiliary substrate. The male screw portion of the second auxiliary substrate is screwed into the female screw portion of the first auxiliary substrate, and the head portion is rotated to tighten the second auxiliary substrate with respect to the first auxiliary substrate such that the capsule is broken and the adhesive flows outward of the first auxiliary substrate via the communication hole.

According to an aspect of the present invention, there is provided a tooth extraction tool set including the tooth extraction auxiliary tool according to the present invention, and a tooth extraction tool having an engagement portion guided to a gap between the second auxiliary substrate and the tooth and engaging with the head portion of the second auxiliary substrate in a state where the first auxiliary substrate is inserted into the recessed portion formed in the tooth.

In the tooth extraction tool set having the above-described configuration, it is preferable that the tooth extraction tool includes a first substrate extending in a longitudinal direction, and a second substrate connected to one end portion of the first substrate in the longitudinal direction and inserted into an oral cavity of a patient, and at least one of an engagement cutout portion that divides a tip portion of the second substrate, and an engagement hole in the second substrate, the engagement hole being configured to include a first hole through which the second auxiliary substrate is allowed to pass in the second substrate and a second hole through which the second auxiliary substrate is not allowed to pass and continuous with the first hole, is formed in the second substrate, as the engagement portion.

In the tooth extraction tool set having the above-described configuration, it is preferable that the second substrate of the tooth extraction tool is formed in a convex curved surface shape, and a bottom portion of the second substrate is formed in a flat shape, or is formed in a convex curved surface shape having a smaller curvature than a periphery of the bottom portion.

### Effect of the Invention

According to the tooth extraction auxiliary tool and the tooth extraction tool set of the present invention, the recessed portion (cavity portion or recess) is formed in the tooth to such an extent that the first auxiliary substrate can be inserted into the recessed portion. In a state where the first auxiliary substrate is inserted into the recessed portion, the second auxiliary substrate 12 is tightened with respect to the first auxiliary substrate. In this manner, the first auxiliary substrate 11 is expanded, and is brought into pressure contact with and fixed to the tooth. Thereafter, a force is applied to the second auxiliary substrate such that the tooth is easily pulled out from a gum. In this manner, a burden on the tooth serving as a tooth extraction target and teeth adjacent to the tooth extraction target can be reduced.

### BRIEF DESCRIPTION OF DRAWINGS

FIG. 1 is a view illustrating a configuration of a tooth extraction auxiliary tool as a first embodiment of the present invention.

FIG. 2 is a view illustrating a configuration of a tooth extraction tool as an embodiment of the present invention.

FIG. 3 is a view illustrating a using method of the tooth extraction auxiliary tool as the first embodiment of the present invention.

FIG. 4 is a view illustrating a using method of the tooth extraction auxiliary tool as the first embodiment of the present invention.

FIG. 5 is a view illustrating a using method of the tooth extraction auxiliary tool as the first embodiment of the present invention.

FIG. 6 is a view illustrating a configuration of a tooth extraction auxiliary tool as a modification example of the first embodiment of the present invention.

FIG. 7 is a view illustrating a configuration of a tooth extraction auxiliary tool as a second embodiment of the present invention.

FIG. 8 is a view illustrating a using method of the tooth extraction auxiliary tool as the second embodiment of the present invention.

### DESCRIPTION OF EMBODIMENTS

### First Embodiment

### (Configuration)

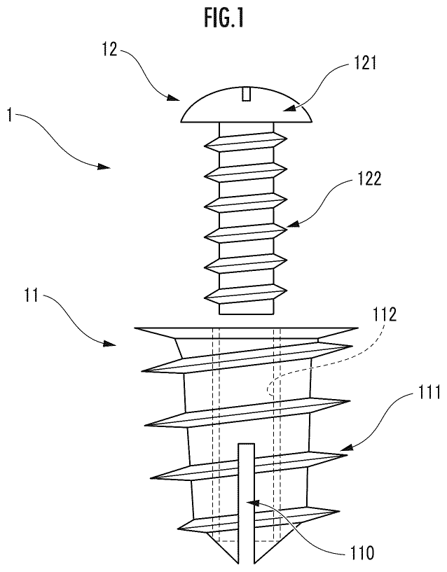

A tooth extraction auxiliary tool 1 as a first embodiment of the present invention illustrated in FIG. 1 includes a first auxiliary substrate 11 and a second auxiliary substrate 12. A material of the tooth extraction auxiliary tool 1 is selected in any desired way. For example, the tooth extraction auxiliary tool 1 is formed of a nickel-titanium alloy.

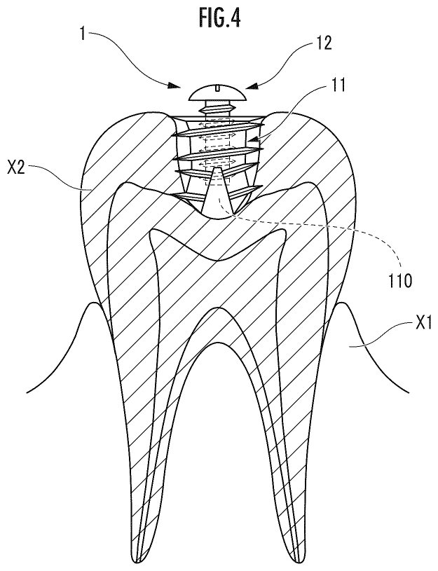

The first auxiliary substrate 11 is formed in a substantially conical trapezoidal shape (more specifically, a shape in which a cone having a smaller inclination than the conical trapezoid is continuously formed on an upper bottom surface of the conical trapezoid). The first auxiliary substrate 11 has a through-hole (or a cavity continuous with a slit 110) extending from a rear end portion to a tip portion in an axial direction. As illustrated in FIG. 4, a size of the first auxiliary substrate 11 is designed to be a size which can be inserted into a recessed portion X0 formed in a tooth crown of a tooth X2 in a state where a tooth root is embedded in a gum X1. A shape of the first auxiliary substrate 11 may be not only the substantially spherical shape, but also a substantially elliptical spherical shape, a substantially hemispherical shape, a substantially cubic shape, a substantially rectangular shape, a substantially cylindrical shape, a substantially square columnar shape, a substantially conical shape, a substantially square conical shape, a substantially conical trapezoidal shape, or a substantially square conical trapezoidal shape. Alternatively, various shapes such as a combination of the above-described shapes and the like may be used. The same applies to other embodiments.

A slit 110 dividing a tip portion into two is formed in the tip portion of the first auxiliary substrate 11. The tip portion of the first auxiliary substrate 11 may be divided into three or more by the slit 110. A protruding portion 111 continuous in a spiral shape and protruding outward in a radial direction while extending in the axial direction is formed on an outer surface of the first auxiliary substrate 11. A shape, a size, the number, and a disposition mode of the protruding portions 111 may be changed in various ways. A female screw portion 112 is formed on an inner surface (side surface of the through-hole) of the first auxiliary substrate 11.

A communication hole of the first auxiliary substrate 11 is designed such that a diameter gradually decreases from a rear end portion or an intermediate portion to the tip portion. This configuration represents a structure for gradually increasing the diameter of the tip portion divided by the slit 110 of the first auxiliary substrate 11 in such a manner that the tip portion of the second auxiliary substrate 12 presses the first auxiliary substrate 11 outward in the radial direction, as the male screw portion 122 of the second auxiliary substrate 12 moves forward to the female screw portion 112 of the first auxiliary substrate 11.

A valley diameter of the female screw portion 112 may be designed to gradually decrease from the rear end portion to the tip portion of the first auxiliary substrate 11. This configuration represents a structure for gradually increasing the diameter of the tip portion of the first auxiliary substrate 11 in such a manner that a peak of the male screw portion 122 presses a valley of the female screw portion 112 outward in the radial direction, as the male screw portion 122 of the second auxiliary substrate 12 moves forward to the female screw portion 112 of the first auxiliary substrate 11.

The second auxiliary substrate 12 is formed in a shape in which a head portion 121 having a substantially annular shape with a larger diameter than a cylinder is continuously provided in one end portion of a substantially cylindrical shape. An engagement portion for a tool such as a driver or a wrench is formed in a top portion of the head portion 121. A shape of the head portion 121 may be not only a substantially cylindrical shape or a substantially disk shape, but also a substantially regular polygonal plate shape, a substantially spherical shape, a substantially elliptical spherical shape, a substantially hemispherical shape, a substantially cubic shape, a substantially rectangular shape, a substantially cylindrical shape, a substantially square columnar shape, a substantially conical shape, a substantially square conical shape, a substantially conical trapezoidal shape, or a substantially square conical trapezoidal shape. Alternatively, various shapes such as a combination of the above-described shapes and the like may be used. The same applies to other embodiments.

The male screw portion 122 screwed into the female screw portion 112 of the first auxiliary substrate 11 is formed on a side surface of the second auxiliary substrate 12.

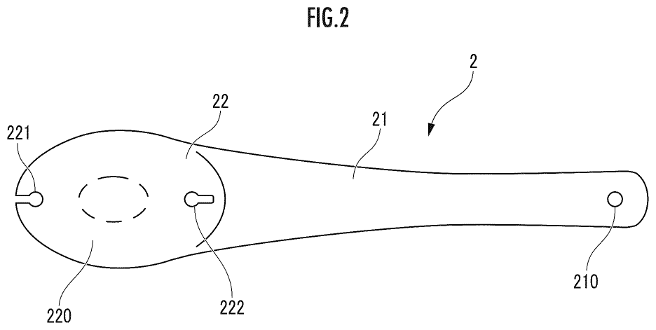

FIG. 2 illustrates a tooth extraction tool 2 forming a tooth extraction tool set together with the tooth extraction auxiliary tool 1 illustrated in FIG. 1. As illustrated in FIG. 2, the tooth extraction tool 2 includes a first substrate 21 having an elongated flat plate-shape in a top view, and a second substrate 22 provided in one end portion of the first substrate 21 in a longitudinal direction and having a substantially oval shape or a substantially elliptical shape in a top view.

A hole 210 for string passage or the like is formed in the other end portion of the first substrate 21. The second substrate 22 is formed in a convex curved surface shape like a spoon as a whole, but is formed to be flat or substantially flat in a bottom portion 220 (meaning that a curvature in the second substrate 22 is smaller than that in a peripheral portion thereof). An engagement cutout portion 221 is formed in the tip portion of the second substrate 22 to divide the tip portion into two forks. A rear end portion of the second substrate 22 has an engagement hole 222 configured to include a substantially circular hole having the diameter larger than the diameter of the head portion 121 of the second auxiliary substrate 12 of the tooth extraction auxiliary tool 1 and a substantially rectangular hole having the diameter smaller than the diameter of the head portion 121 of the second auxiliary substrate 12 continuous behind the substantially circular hole. The engagement cutout portion 221 reaches an edge portion of the second substrate 22, but the engagement hole 222 does not reach an edge portion of the second substrate 22 (portion continuous with the first substrate 21). Instead of the engagement cutout portion 221, an engagement hole similar to the engagement hole 222 may be formed in the tip portion of the second substrate 22.

### (Using Method)

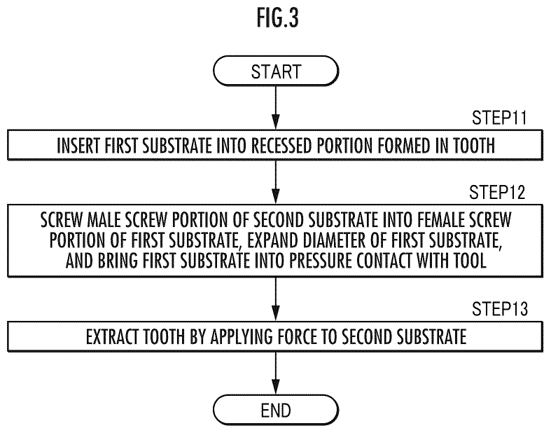

A using method of the tooth extraction auxiliary tool 1 and the tooth extraction tool 2 which have the above-described configuration will be described. First, as illustrated in FIG. 4, a recessed portion X0 having such a size that the first auxiliary substrate 11 can be inserted into the tooth crown of the tooth X2 is formed by a cutting tool. Thereafter, the tip portion of the male screw portion 122 is screwed into the female screw portion 112. In this manner, the tooth extraction auxiliary tool 1 in a state where the first auxiliary substrate 11 and the second auxiliary substrate 12 are screwed is guided into an oral cavity of a patient, and the first auxiliary substrate 11 is inserted into the recessed portion X0 (FIG. 3/STEP 11).

Next, the second auxiliary substrate 12 is relatively rotated with respect to the first auxiliary substrate 11 via the head portion 121 by using a suitable tool. In this manner, the male screw portion 122 is moved forward to the tip portion of the first auxiliary substrate 11. In this case, the first auxiliary substrate 11 may rotate inside the recessed portion X0 of the tooth X2, and the spiral protruding portion 111 may be stopped by being bitten into or caught on the tooth X2. In response thereto, the second auxiliary substrate 12 presses the first auxiliary substrate 11 outward in the radial direction to push and widen the slit 110, and gradually increases the diameter of the tip portion of the first auxiliary substrate 11. In this manner, the protruding portion 111 formed on the outer surface of the first auxiliary substrate 11 is bitten into the tooth X2 defining the recessed portion X0 or the tooth crown, and the first auxiliary substrate 11 is fixed to the tooth X2 (FIG. 3/STEP 12).

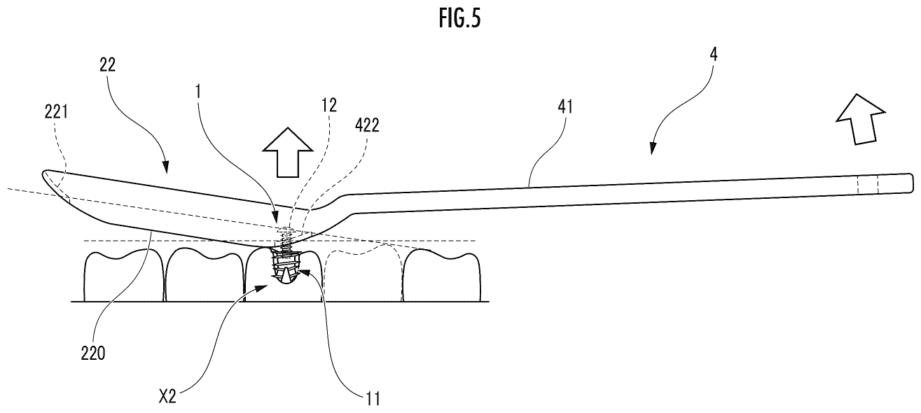

As illustrated in FIG. 5, while an operator gripping the first substrate 21 of the tooth extraction tool 2 searches for an upper surface portion of dentition adjacent to the tooth X2 in the bottom portion 220 (in a direction in which the second substrate 22 is inserted into the oral cavity), the engagement hole 222 of the second substrate 22 is hooked on the head portion 121 of the second auxiliary substrate 12 of the tooth extraction auxiliary tool 1. Thereafter, the tooth extraction tool 2 is moved in a direction away from the gum X1 such that the tooth X2 is pulled out from the gum X1 together with the tooth extraction auxiliary tool 1 (refer to FIG. 3/STEP 13).

The flat or substantially flat bottom portion 220 of the substantially spoon-shaped second substrate 22 enables the operator to search for not only the upper surface portion of the dentition but also corners of the dentition. It is possible to search for a corner portion of the tooth and a stepped portion of the dentition. Accordingly, the operator can adapt himself or herself to individual circumstances such as a status in which a mouth of a patient is less likely to open and/or a shape of the mouth, a posture of the operator, tooth alignment and/or engagement of the patient, and the like.

While the operator gripping the first substrate 21 of the tooth extraction tool 2 searches for the upper surface portion of the dentition adjacent to the tooth X2 in the bottom portion 220 of the second substrate 22 (in a direction opposite to the direction in which the second substrate 22 is inserted into the oral cavity), the engagement cutout portion 221 in the tip portion of the second substrate 22 may be hooked on the head portion 121 of the second auxiliary substrate 12 of the tooth extraction auxiliary tool 1. The first substrate 21 of the tooth extraction tool 2 may be pushed, and the tooth X2 may be pulled out from the gum X1 together with the tooth extraction auxiliary tool 1.

In this way, the tooth adjacent to the teeth X2 is less affected, and the tooth can be safely, stably, and easily extracted. Therefore, a burden on the patient and a burden on the operator in carrying out tooth extraction work are reduced. The shape of the second substrate 22 is a substantially oval shape in a top view. Therefore, the patient feels less resistance when the second substrate 22 is inserted into the oral cavity of the patient. In this sense, the patient feels relieved.

The tooth extraction auxiliary tool 1 may be gripped in the head portion 121 of the second auxiliary substrate 12 with a finger by the operator, and the tooth X2 may be pulled out from the gum X1.

### Modification Example of First Embodiment

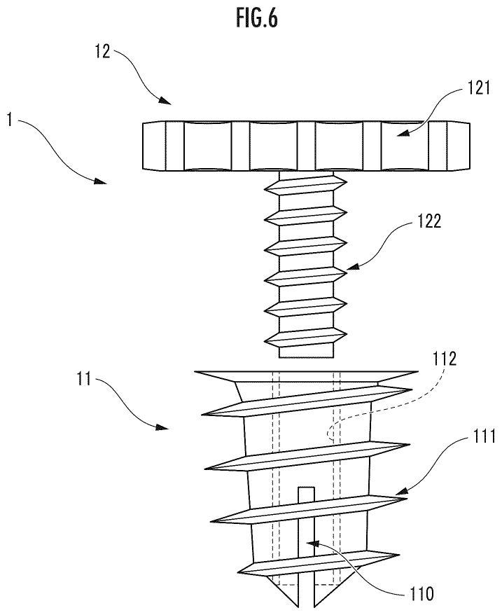

FIG. 6 illustrates the tooth extraction auxiliary tool 1 as a modification example of the first embodiment of the present invention. The configuration of the head portion 121 of the second auxiliary substrate 12 is different from the configuration of the tooth extraction auxiliary tool 1 illustrated in FIG. 1. Other points are the same as those of the tooth extraction auxiliary tool 1 illustrated in FIG. 1. Therefore, the same reference numerals are used for the same configurations, and description thereof will be omitted. The head portion 121 has a substantially disk shape, and a recessed stripe portion 1210 recessed inward in the radial direction while extending in the axial direction is formed on an outer surface of the head portion 121.

When the second auxiliary substrate 12 is gripped in the head portion 121 by a thumb, an index finger and/or a middle finger and a rotational force or a twisting force is applied around a central axis thereof, slipping between the finger and the second auxiliary substrate 12 due to saliva or the like is suppressed. When the tooth X2 floats from the gum X1 due to the twisting force applied to the tooth X2, the second auxiliary substrate 12 is strongly gripped by the fingers, or the tooth X2 is pulled out from the gum X1 in a state where the tooth X2 is pinched between jaw portions of a forceps (tooth is extracted). The tooth may be extracted by using the tooth extraction tool 2.

### Second Embodiment

### (Configuration)

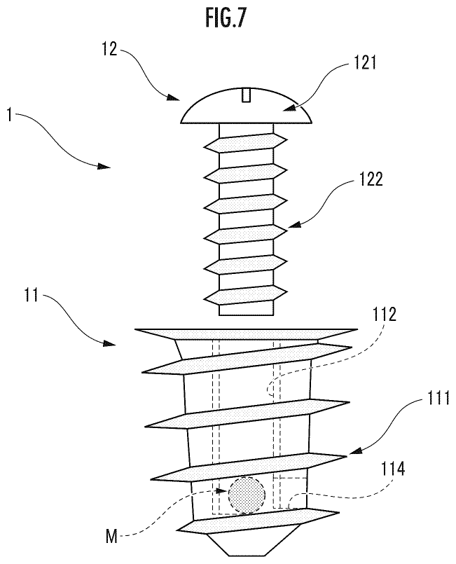

The tooth extraction auxiliary tool 1 as the second embodiment of the present invention illustrated in FIG. 7 is different from the tooth extraction auxiliary tool 1 as the first embodiment of the present invention illustrated in FIG. 1 in the configuration of the first auxiliary substrate 11. Other points are the same as those of the tooth extraction auxiliary tool 1 illustrated in FIG. 1. Therefore, the same reference numerals are used for the same configurations, and description thereof will be omitted.

The first auxiliary substrate 11 is formed in a substantially conical trapezoidal shape (more specifically, a shape in which a cone having a smaller inclination than the conical trapezoid is continuously formed on an upper bottom surface of the conical trapezoid). A cavity extending from the rear end portion in the axial direction is formed in the first auxiliary substrate 11, and a communication hole 114 extending from a bottom portion of the cavity outward or sideways in the radial direction and communicating with the outside via an opening portion of a side surface of the first auxiliary substrate 11 is formed. The communication hole 114 may be formed to extend from the bottom portion of the cavity in the axial direction and to communicate with the outside via the opening portion of the tip portion of the first auxiliary substrate 11. A capsule filled with an adhesive M is installed in the bottom portion of the cavity.

The slit 110 is not formed in the tip portion of the first auxiliary substrate 11. A protruding portion 111 continuous in a spiral shape and protruding outward in a radial direction while extending in the axial direction is formed on an outer surface of the first auxiliary substrate 11. A shape, a size, the number, and a disposition mode of the protruding portions 111 may be changed in various ways. The female screw portion 112 is formed on an inner surface (side surface of the cavity extending in the axial direction) of the first auxiliary substrate 11. The valley diameter of the female screw portion 112 is designed to have a constant value from the rear end portion to the tip portion of the first auxiliary substrate 11. In the present embodiment, the reason is that it is not necessary to increase the diameter of the first auxiliary substrate 11.

### (Using Method)

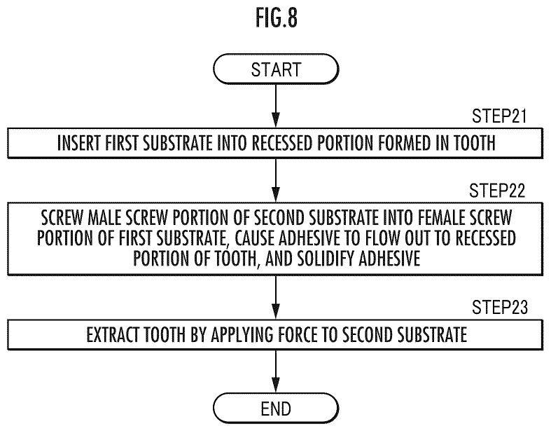

A using method of the tooth extraction auxiliary tool 1 and the tooth extraction tool 2 which have the above-described configuration will be described. First, a recessed portion X0 having such a size that the first auxiliary substrate 11 can be inserted into the tooth crown of the tooth X2 is formed by a cutting tool. (refer to FIG. 4). Thereafter, the tip portion of the male screw portion 122 is screwed into the female screw portion 112. In this manner, the tooth extraction auxiliary tool 1 in a state where the first auxiliary substrate 11 and the second auxiliary substrate 12 are screwed is guided into the oral cavity of the patient, and the first auxiliary substrate 11 is inserted into the recessed portion X0 (FIG. 8/STEP 21).

Next, the second auxiliary substrate 12 is relatively rotated with respect to the first auxiliary substrate 11 via the head portion 121 by using a suitable tool. In this manner, the male screw portion 122 is moved forward to the tip portion of the first auxiliary substrate 11. In this case, the first auxiliary substrate 11 may rotate inside the recessed portion X0 of the tooth X2, and the spiral protruding portion 111 may be stopped by being bitten into or caught on the tooth X2. In this manner, the capsule installed in the bottom portion of the first auxiliary substrate 11 is broken by the tip portion of the second auxiliary substrate 12. The adhesive M flows outward, and flows into the recessed portion X0 of the tooth X2 via the communication hole 114. The adhesive is solidified to fix the first auxiliary substrate 11 to the tooth X2 (FIG. 8/STEP 22).

As illustrated in FIG. 5, while an operator gripping the first substrate 21 of the tooth extraction tool 2 searches for an upper surface portion of dentition adjacent to the tooth X2 in the bottom portion 220 (in a direction in which the second substrate 22 is inserted into the oral cavity), the engagement hole 222 of the second substrate 22 is hooked on the head portion 121 of the second auxiliary substrate 12 of the tooth extraction auxiliary tool 1. Thereafter, the tooth extraction tool 2 is moved in a direction away from the gum X1 such that the tooth X2 is pulled out from the gum X1 together with the tooth extraction auxiliary tool 1 (FIG. 8/STEP 23).

### INDUSTRIAL AVAILABILITY

According to the tooth extraction auxiliary tool 1 and the tooth extraction tool set in the present invention, even patients such as children and/or elderly persons and the like feel relieved, safe, and less burdensome when the tooth is extracted. The tooth extraction auxiliary tool 1 and the tooth extraction tool set according to the present invention are also applicable to tooth extraction of pets or domestic animals.

### DESCRIPTION OF REFERENCE NUMERALS

1: tooth extraction auxiliary tool
2: tooth extraction tool
11: first auxiliary substrate
12: second auxiliary substrate
21: first substrate
22: second substrate
110: slit
111: protruding portion
112: female screw portion
121: head portion
122: male screw portion
X0: recessed portion
X1: gum
X2: tooth
M: adhesive

1. A tooth extraction auxiliary tool comprising:
a first auxiliary substrate inserted into a recessed portion formed in a tooth; and
a second auxiliary substrate,
wherein a slit dividing a tip portion and a through-hole extending from a rear end portion to the tip portion are formed in the first auxiliary substrate, and a female screw portion is formed on an inner surface of the first auxiliary substrate,
the second auxiliary substrate has a head portion, and a male screw portion extending from the head portion is formed in the second auxiliary substrate, and
the male screw portion of the second auxiliary substrate is screwed into the female screw portion of the first auxiliary substrate, and the head portion is rotated to tighten the second auxiliary substrate with respect to the first auxiliary substrate such that the slit is pushed and widened and the tip portion of the first auxiliary substrate which is divided by the slit is expanded.

2. The tooth extraction auxiliary tool according to claim 1,
wherein the through-hole is formed in the first auxiliary substrate such that a diameter is reduced at least from an intermediate portion to the tip portion.

3. The tooth extraction auxiliary tool according to claim 1,
wherein the female screw portion is formed in the first auxiliary substrate such that a valley diameter is reduced at least from an intermediate portion to the tip portion.

4. The tooth extraction auxiliary tool according to claim 1,
wherein a protruding portion is formed on an outer surface of the first auxiliary substrate.

5. A tooth extraction auxiliary tool comprising:
a first auxiliary substrate inserted into a recessed portion formed in a tooth; and
a second auxiliary substrate,
wherein a cavity extending from a rear end portion and a communication hole through which the cavity communicates with an external space are formed in the first auxiliary substrate, a female screw portion is formed on an inner surface of the first auxiliary substrate, and a capsule filled with an adhesive is installed in the cavity,
the second auxiliary substrate has a head portion, and a male screw portion extending from the head portion is formed in the second auxiliary substrate, and
the male screw portion of the second auxiliary substrate is screwed into the female screw portion of the first auxiliary substrate, and the head portion is rotated to tighten the second auxiliary substrate with respect to the first auxiliary substrate such that the capsule is broken and the adhesive flows outward of the first auxiliary substrate via the communication hole.

6. A tooth extraction tool set comprising:
the tooth extraction auxiliary tool according to claim 1; and
a tooth extraction tool having an engagement portion guided to a gap between the second auxiliary substrate and the tooth and engaging with the head portion of the second auxiliary substrate in a state where the first auxiliary substrate is inserted into the recessed portion formed in the tooth.

7. The tooth extraction tool set according to claim 6,
wherein the tooth extraction tool includes a first substrate extending in a longitudinal direction, and a second substrate connected to one end portion of the first substrate in the longitudinal direction and inserted into an oral cavity of a patient, and
at least one of an engagement cutout portion that divides a tip portion of the second substrate, and an engagement hole in the second substrate, the engagement hole being configured to include a first hole through which the second auxiliary substrate is allowed to pass in the second substrate and a second hole through which the second auxiliary substrate is not allowed to pass and continuous with the first hole, is formed in the second substrate, as the engagement portion.

8. The tooth extraction tool set according to claim 7,
wherein the second substrate of the tooth extraction tool is formed in a convex curved surface shape, and a bottom portion of the second substrate is formed in a flat shape, or is formed in a convex curved surface shape having a smaller curvature than a periphery of the bottom portion.
